(19) United States
(12) Patent Application Publication
(10) Pub. No.: US 2017/0069937 A1
(43) Pub. Date: Mar. 9, 2017

(54) MODULE WITH A FLUID ENERGY MACHINE

(71) Applicant: Siemens Aktiengesellschaft, Munich (DE)

(72) Inventors: Michael Kühne, Fürth (DE); Michael Zach, Nürnberg (DE)

(73) Assignee: Siemens Aktiengesellschaft, Munich (DE)

(21) Appl. No.: 15/123,142

(22) PCT Filed: Feb. 26, 2015
(86) PCT No.: PCT/EP2015/054045

§ 371 Date: Sep. 1, 2016

(30) Foreign Application Priority Data
Mar. 11, 2014 (DE) 10 2014 204 414.6

(51) Int. Cl. H01M 10/39; F04D 13/04; F04D 13/02; H01M 10/6568; H01M 10/615

(52) U.S. Cl. CPC H01M 10/39; H01M 10/6568; H01M 10/615; F04D 13/024; F04D 13/04

(57) ABSTRACT

A module with a module housing which is at least partly filled with a thermofluid, the thermofluid being designed in particular for an operating temperature range of 200° C. to 400° C. Furthermore, a fluid energy machine is arranged in the module housing or is partly integrated into the module housing, the fluid energy machine having a drive unit and a transporting unit which are coupled to each other in order to transmit a rotational force. The drive unit is fluidically connected to at least one fluid line of an at least partly external fluid circuit such that the drive unit is energized by a fluid flow in the fluid line, and the drive unit does not have other connections for supplying from another external energy source.

### CROSS REFERENCE TO RELATED APPLICATIONS

This application is the US National Stage of International Application No. PCT/EP2015/054045 filed Feb. 26, 2015, and claims the benefit thereof. The International Application claims the benefit of German Application No. DE 102014204414.6 filed Mar. 11, 2014. All of the applications are incorporated by reference herein in their entirety.

### FIELD OF INVENTION

The present invention relates to a module, having a module enclosure that is at least partly filled with a thermofluid, which thermofluid is designed in particular for an operating temperature range of between 200° C. and 400° C., as well as to a system comprising at least two such modules, and to a fluid energy machine that can be contained by such a module.

### BACKGROUND OF INVENTION

Such modules with thermofluid serve primarily to enclose thermal components that, in operation, must be supplied with thermal energy or that emit thermal energy when in operation. The modules are, for example, high-temperature battery modules, such as those used, for instance, in the technology of sodium sulfide or sodium nickel chloride batteries. The operation of such modules requires a suitable heat management system that ensures that the required operating temperatures are not exceeded or under-attained. Particularly in the case of high-temperature battery cells that are electrically interconnected in a module, it is important, as inherent in the design, to maintain a predefined temperature range in order, on the one hand, not to damage the high-temperature battery cells themselves by overheating, and on the other hand not to allow the internal resistance of these batteries to increase to unacceptably high values as a result of excessive cooling.

Such modules, which require a thermal management system, frequently have a thermofluid that is used as a medium for heat transfer. The thermofluid in this case normally directly or indirectly flows around the structural elements and components in the module that are to be temperature-controlled, in order to ensure the required heat transport.

Thorough fluidic mixing of the thermofluid is required to enable a sufficiently high heat transfer rate to be effected between the thermofluid and the components or structural elements to be temperature-controlled. Normally, the imparting of a flow in order to achieve the thorough mixing requires the use of suitable flow generators, which are typically realized in the form of pumps. By means of suitable electric motors, such pumps are supplied with a sufficient torque to operate a transport unit, such that the pump can impart a flow to the thermofluid. If such electrically operated pumps are used in combination with a previously described module that is operated at temperatures of over 200° C., the transport unit is normally disposed within the module enclosure, and the driving electric motor disposed outside of the module enclosure, in a region that is substantially at ambient temperature. Consequently, in order to transmit torque between the electric motor and the transport unit, it is necessary to provide an opening in the module enclosure, which must be sealed against leakages of thermofluid and also against gases or other fluids entering the module.

A disadvantage of such embodiments is that, on the transport unit side, the pump is normally charged with thermal energy that is lost toward the electric motor, via the opening, which typically cannot be thermally insulated to a sufficient extent. In addition to such an unwanted thermal loss (thermal self-discharge), it is necessary, in particular also in the case of a spatially constrained design, to provide an active cooling on the electric motor side, in order to protect the electric motor and its components against overheating.

A further problem, also, is the thermal stability of the electrical components, which, particularly at temperatures of over 200° C., become highly susceptible to faults and have to be replaced prematurely. Furthermore, such components can also easily sustain damage if temperature fluctuations occur at such high temperatures. Temperature fluctuations that can cause voltage damage are to be expected precisely, for instance, in operation of high-temperature battery cells in such a module.

### SUMMARY OF INVENTION

Consequently, there ensues the technical object of proposing a module that in regular operation is operated, in particular, at temperatures of over 200° C. and that is connected in an energetically advantageous manner to a flow generator having an advantageous thermal power dissipation, and that has comparatively little or no cooling requirement. Moreover, it is technically necessary to reduce the fault susceptibility in electrical or electronic components, and to reduce the servicing work requirement for such components. In particular, a module with thermofluid is to be proposed, which can be provided largely without external mechanical interventions, and which allows a simple fluidic interconnection. In addition, it is a technical requirement to propose an improved design with respect to the power density of an overall system that comprises a plurality of modules.

These objects on which the invention is based are achieved by a module, and by a system as claimed.

In particular, the objects on which the invention are based are achieved by a module, having a module enclosure that is at least partly filled with a thermofluid, which thermofluid is designed in particular for an operating temperature range of between 200° C. and 400° C., wherein furthermore a fluid energy machine is disposed in the module enclosure or is partly integrated into the module enclosure (2), which fluid energy machine has a drive unit and a transport unit, which are each coupled to the other for the purpose of transmitting a rotational force, and wherein the drive unit is fluidically connected to at least one fluid line of an at least partly external fluid circuit, in such a manner that it can be energized by a fluid stream in the fluid line, and wherein the drive unit does not have any other connection for supply by a further, external, energy source.

Furthermore, the objects on which the invention are based are achieved by a system comprising at least two modules according to the type described above, and also in the following, wherein the at least two modules are both fluidically connected to a single, at least partly external, fluid circuit for the purpose of energizing the respective drive units of the modules.

Furthermore, a fluid energy machine is described, comprising a drive unit and a transport unit, which are each coupled to the other for the purpose of transmitting a rotational force, in particular for the purpose of generating a flow in a thermofluid of a module according to the above, and also following embodiments, wherein the drive unit can be fluidically coupled to a fluid line in such a manner that it can be energized by a fluid stream in the fluid line, wherein the drive unit has no other connection for supply by a further, external, energy source.

It is to be pointed out at this juncture that the module according to the invention may also typically have appropriate connections for the fluid circuit, such that, by simple interconnection of a plurality of modules, the at least partly external circuit can easily be connected to the modules. This facilitates not only the connection, but also the replacement, of such modules that are interconnected to form a system.

The term at least partly external fluid circuit relates to a fluid circuit that is not routed, or not fully routed, in the module enclosure. In particular, the predominant portion of the external fluid circuit is to be routed outside of the module enclosure, a lesser portion then being routed within a module, only after an opening through the module enclosure. In particular, a pump, that is provided with the fluid circuit for the purpose of driving the fluid inside the latter, is to be disposed externally, i.e. outside of the modules.

Moreover, it is to be pointed out that a design of the thermofluid for an operating temperature range of between 200° C. and 400° C. requires that the respective module can also be operated, or is operated, at the temperatures. If the thermofluid is intended for operation in this temperature range, this also applies to the module.

It is provided according to the invention to provide a module with a fluid energy machine in such a manner that either the drive unit thereof, and also the transport unit thereof, are disposed entirely in the module enclosure or, alternatively, portions of the fluid energy machine are integrated in the module enclosure, such that a part of the fluid energy machine is disposed within the module enclosure. Further, the present invention allows a hydraulic separation of an external fluid circuit and a flow field of the thermofluid in the module. That is to say, the fluid energy machine can thus be operated without fluidic exchange with the thermofluid in the module in such a manner that the fluid energy machine is energized only by an externally generated fluid stream. This fluid stream is made available to the drive unit via a fluid line of the fluid circuit, and can consequently selectively operate the fluid energy machine.

The transport unit is furthermore designed in such a manner that there is a fluidic connection to the thermofluid in the module, such that a flow can be imparted to the thermofluid by the transport unit. With a suitable geometric arrangement of the transport unit, this flow can cause a flow within the module, and thus bring about an advantageous transfer of heat between the thermofluid and the structural elements and components that are to be supplied with heat.

Owing to the drive unit being driven by means of the fluid flow in the at least partly external fluid circuit, it is possible to dispense with an electric drive. According to the invention, an electric drive unit is expressly not provided. Consequently, also, no electrical or electronic components can be damaged and thus fail prematurely. In this case, the fluidic drive by means of the fluid stream is far less temperature-sensitive. In addition, the fluid can be selectively matched for operation at high temperature. The drive unit can thus also be operated largely without servicing, for example if suitable fluids are selected. Advantageous fluids are, for instance, thermal oils, which are not only largely unproblematic in respect of a high operating temperature, but also additionally have a material protecting and lubricating effect.

For the purpose of generating a fluid stream in the fluid line of the at least partly external fluid circuit, the latter typically has a pump to generate the fluid stream. Thus, advantageously, only one central energizing unit, for example the pump, which is connected to the fluid circuit, is required to supply energy to a plurality of modules. This reduces the complexity and the number of structural elements and components for an individual thermal management system in the individual modules.

It is to be pointed out at this juncture that the module and system according to the invention are particularly designed for an operating temperature range of between 200° C. and 400° C. Such temperature ranges are advantageous, in particular, for high-temperature battery modules that operate, for instance, on the principle of the technology of NaS or NaNiCl₂ cells. Since such cells sometimes require high rates of heat exchange between the cells and a thermofluid, the present invention is particularly suitable for such cells, or such temperature ranges.

According to an embodiment of the invention, it may be provided that the thermofluid at least partly surrounds the fluid energy machine and interacts thermally with the latter. The fluid energy machine may also be fully embedded in the thermofluid, such that there is no longer a need to make any further structural provisions for a fluidic coupling of the two. Owing to the thermal integration of the fluid energy machine, the latter can moreover also be provided for thermal interaction with the thermofluid, such that, for instance in the case of the fluid energy machine being supplied with thermally conditioned fluid in the fluid line, a thermal conditioning of the thermofluid can also be effected indirectly in the module, via the fluid energy machine.

According to the invention, it may be provided that the fluid energy machine is partly integrated into the module enclosure. Thus, for instance, the transport unit may be disposed in the module enclosure, the drive unit being disposed outside of the module enclosure. For fluidic sealing of the module enclosure, a part of the housing of the fluid energy machine, for instance, may be connected to the module enclosure in a fluid-tight manner, in particular welded. Likewise, only one coupling component may be connected to the module enclosure in a fluid-tight manner, such that the drive unit and the transport unit can be attached to the coupling component on both sides, in particular can be placed on and secured mechanically. Such a coupling component may be realized as a magnetic coupling.

Furthermore, the fluid energy machine is of a modular construction, wherein individual machine modules can be connected to each other by means of secured plug connections.

Such machine modules may be, for instance, the transport unit and the drive unit.

According to an embodiment of the invention, the module is realized as a storage module having a number of high-temperature battery cells (e.g. NaS or NaNiCl₂ cells). The number in this case may be “one”, or also a number greater than “one”. As will be easily understood by persons skilled in the art, however, the present invention can also be used outside of electrochemical applications, namely, whenever temperature control is to be effected in a module by a thermofluid to which a flow is imparted.

Furthermore, it is to be pointed out that the fluid energy machine is not intended to have any further connections for supply by an external energy source. In particular, the drive unit thus also does not have any electrical connections. The energizing of the fluid energy machine is thus effected exclusively by the transmission of torque from the fluid stream to a drive means in the drive unit.

Furthermore, it is to be pointed out that the fluid line may also be realized merely as a fluid connection on the fluid energy machine, in which a fluid stream is realized. It is thus conceivable, for example, that the fluid connection connects the fluid energy machine, disposed in or on the module, to the module enclosure, via an opening in the latter. The supply of fluid to this fluid connection may be effected, for example, from a volume in which no directed fluid stream is yet realized, such that the fluid line with the directed fluid stream is realized only by the fluid connection.

In providing each module with an associated fluid energy machine, the present invention also differs from respective methods for imparting a flow to the thermofluid of individual modules in a system. Such methods for imparting a fluid flow to the thermofluid, according to the internally known prior art, dispense entirely, for example, with a module-bound fluid energy machine or pump. Thus, for example, individual modules can only be interconnected fluidically, an external pump unit applying a fluid flow to the individual modules. In this case, it is necessary for the thermofluid in the module to be identical to the fluid that is transported in the at least partly external fluid line. A disadvantage of such embodiments, however, is that the individual modules may be subjected to differing pressures and consequently, in the case of the modules being connected in parallel, to differing flows that, in effect, can only be managed in a controlled manner by a considerable amount of additional resource. Moreover, in the case of these embodiments, it would scarcely be possible to ensure that all fluidically interconnected modules are supplied at a comparable heat flow rate Likewise, such technical solutions would require a very complex venting of the individual modules, in order to avoid any air bubbles, which could otherwise have a negative effect on the service life of the thermofluid. It would additionally be necessary to implement yet further measures to enable easy replacement the individual modules from the overall system without jeopardizing the operation of the remaining modules.

Such disadvantages can easily be avoided by the spatial, and also hydraulic, decoupling of the fluid stream and thermofluid inside the module, according to the invention. It is additionally possible to achieve an only very slight, and therefore very advantageous, connection without pressure shocks (possibly caused by cavitation, ebullition bubbles, starting torques, etc.) in the at least partly external fluid circuit being directly transmitted to the thermofluid in the module. In particular, if there are mechanically sensitive structural elements disposed in the module, such as, for example, individual high-temperature battery cells or the bearing of the pump unit, such a comparatively softer connection can prove to be very gentle on components, and therefore advantageous.

Moreover, the spatial decoupling of the interior of the module and the fluid circuit allows separate selection or adaptation of the fluid properties. For example, it is not necessary, for instance, for the fluid carried in the at least partly external fluid circuit to have an electrical insulating effect, since it cannot come into contact, for example, with electrically conductive components.

Furthermore, since the fluid energy machine is integrated into a module, it is also possible to produce a module that can be easily manipulated and replaced. The heat bridge, that between the transport unit and the drive unit, that is problematic according to the prior art, can now be spatially displaced, for instance to a flow generator (pump) that is centrally connected to the fluid circuit, if, for instance, an additional insulation is provided around the modules and the fluid energy machines.

Complete integration of the fluid energy machine into the hot region of the module also makes it possible to achieve a lesser specific space requirement, this having a major design advantage, especially in the case of a system having a plurality of such modules.

According to an embodiment of the invention, it is provided that the drive unit and the transport unit are coupled to each other by means of at least one magnetic coupling, in particular by means of two magnetic couplings. The provision of a magnetic coupling between the drive unit and the transport unit enables good hydraulic decoupling of fluid in the outer fluid circuit and the thermofluid provided in the module, only a damped transmission of force to the transport unit being effected, in particular, in the case of changes in the fluid stream supplying the drive unit. Owing to such a damping, pressure shocks that propagate, in particular, in the fluid line, or rapid flow variations are transmitted only in damped form to the thermofluid in the module(s). In particular, such a decoupling proves to be very advantageous if structural elements liable to sustain damage under mechanical load are provided in the module. It is especially advantageous if the module enclosure is connected to the at least one magnetic coupling in a fluid-tight manner. In such an embodiment, the drive unit, for instance, can easily be removed from the magnetic coupling in order to replace it, with no need to open the module itself. The magnetic coupling in this case is integrated, for instance, in a wall of the module enclosure and connected to the latter, for example welded.

According to a further embodiment of the invention, it is provided that the transport unit is designed to impart a flow to the thermofluid in the module, which flow is suitable, in particular, for thermally conditioning the module by interaction with the thermofluid. Likewise, clearly, other components disposed in the module can also be thermally conditioned thereby, for instance also battery cells, in the case of a module for enclosing a number of electrically interconnected battery cells, in particular high-temperature battery cells, which are typically operated at temperatures of between 200° C. and 400° C. It is thus also conceivable, furthermore, to supply each module, not only with mechanical energy, but also with thermal energy, via the fluid stream realized in the fluid line. This form of coupled energy provision requires a significantly less elaborate management for the individual modules, and thereby reduces both the costs and the number of components used.

According to a further advantageous embodiment of the invention, it is provided that the fluid in the fluid line differs from the thermofluid in the module. In particular, the fluid in the fluid line may be a thermofluid of lesser quality, or also an electrically non-insulating thermofluid. This embodiment proves to be advantageous, in particular, if the thermofluid is used in an operating temperature range of between 200° C. and 400° C., the thermofluid typically being realized as a thermal oil, since sometimes less expensive thermal oils that, for example, do not have to meet a high standard in respect of electrical conductivity, can be carried in the fluid line of the fluid circuit. Likewise, it is possible for the fluid in the at least partly external fluid circuit to be optimized according to application, without also matching the thermofluid in the module.

According to a further advantageous aspect of the invention, it is possible for the fluid circuit to be thermally connected to a heating device, in particular outside of the module, by means of which the fluid in the fluid line can be thermally conditioned. Consequently, the module can be supplied, not only with mechanical energy for driving the drive unit, but also with thermal energy, which serves to thermally condition the thermofluid in the module in an appropriate manner. As already explained further above, such a module can be simultaneously supplied with both mechanical and thermal energy via a fluid circuit.

According to a further embodiment of the invention, it is provided that the module is realized in a fluid-tight manner. The fluid tightness relates both to a tightness with respect to ingress and emergence of the thermofluid, but also with regard to fluids that are outside of the module. It is thus necessary, especially in the case of high-temperature applications, that gases such as oxygen cannot enter the interior of the module, in order thus to prevent premature degradation of the fluid, or the risk of fire or explosion. Moreover, a fluid-tight design of the module also makes it possible to achieve an advantageous thermal decoupling of the module toward the outside.

According to a further embodiment of the system according to the invention, it is provided that the at least partly external fluid circuit has a number of valves, which are designed to adjust the fluid stream in the fluid line to or in a module. Such valves may be realized, for example, as adjustable throttle flaps. In addition, each module can also be appropriately supplied with a predefined quantity of kinetic energy, as well as thermal energy, by the open-loop or closed-loop valve control. To that extent, the specific embodiment allows individual open-loop or closed-loop control of the individual modules with respect to the strength of the flow imparted to the thermofluid in the individual modules, and with respect to the delivery or, also, removal of heat. The provision of such valves is particularly suitable in the case of a hydraulic parallel connection of the at least two modules.

According to an enhancement of the fluid energy machine, it may be provided that the drive unit and the transport unit are coupled to each other by means of at least one magnetic coupling, in particular by means of two or more magnetic couplings. The coupling in this case is realized, in particular, in a frictional, or damped frictional, manner. For the advantages of such an embodiment, reference should be made to the statements relating to this given above.

According to an alternative or, also, enhancing embodiment of the fluid energy machine, it may be provided that the drive unit and the transport unit are coupled to each other by means of a magnetically coupled connecting shaft. In this case, the drive unit, for instance, has its own drive shaft, and the transport unit has a transport shaft that differs from the latter. The magnetically coupled connecting shaft connects the two shafts coaxially and, in particular, is coupled on both sides, via a magnetic coupling in each case, to the drive unit and to the transport unit. To that extent it is possible, for instance, to remove both the drive unit and the transport unit, by pulling to release the magnetic coupling, and for instance to replace them if necessary. Owing to the double magnetic coupling, an advantageous damping of the transport flow can be achieved in the case of changes in the fluid stream for energizing the drive unit.

The invention is to be explained in greater detail in the following on the basis of individual figures. It is to be pointed out in this case that the embodiments shown in the figures are to be understood to be merely schematic, and no limitation with respect to realizability ensues therefrom.

It is also to be pointed out that the components denoted by the same references in the figures also have the same technical functions.

Furthermore, it is to be pointed out that any combinations of the technical features stated in the following are claimed in the present case, insofar as they are suitable for achieving the objects on which the invention is based.

### BRIEF DESCRIPTION OF THE DRAWINGS

There are shown in:

FIG. 1 a first embodiment of the module 1 according to the invention, in a schematic view;

FIG. 2 a second embodiment of the module 1 according to the invention, in a schematic view;

FIG. 3 a first embodiment of the system 100 according to the invention, in a schematic view;

FIG. 4 a schematic sectional drawing, from the side, through an embodiment of a fluid energy machine 10.

### DETAILED DESCRIPTION OF INVENTION

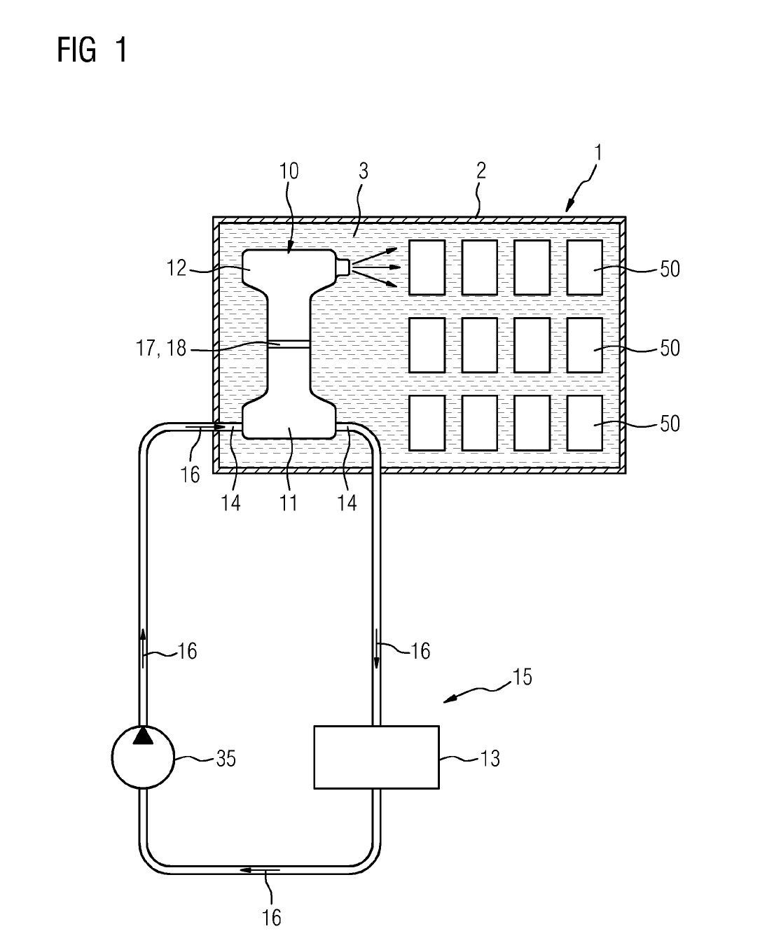

FIG. 1 shows a schematic view of a first embodiment of the module 1 according to the invention, which is provided with a fluid energy machine 10. The fluid energy machine 10 in this case is disposed entirely within the module enclosure 2, and has only connections to fluid lines 14, which go through the module enclosure 2.

The module 1 according to the embodiment is realized, for example, as a storage module, disposed in which there are, for instance, high-temperature battery cells 50. These high-temperature battery cells 50 are typically electrically interconnected, and embedded in a regular geometric arrangement in the thermofluid 3 that at least partly fills the module 1. In particular, the module 1 is completely filled by the thermofluid 3.

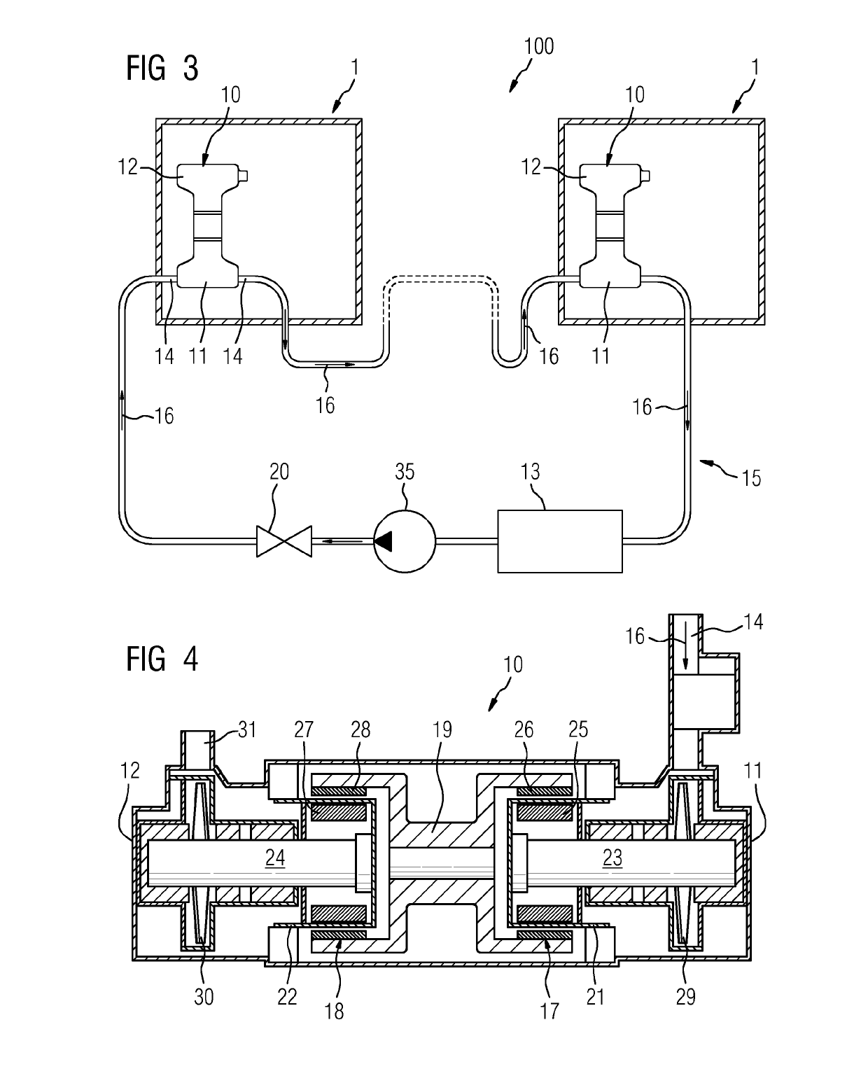

The fluid energy machine 10, in addition to having a drive unit 11, has a transport unit 12, which are coupled to each other, for the purpose of transmitting torque, by at least one magnetic coupling 17, 18 (according to the embodiment, there may be precisely one magnetic coupling, two magnetic couplings, or more than two). A possible embodiment of this fluid energy machine 10 is represented, for example, in FIG. 3.

If the fluid energy machine 10 is then to effect a flow of the thermofluid 3 in the module 1, it is necessary for the drive unit 11 to be energized. This is achieved by applying a fluid stream 16 in the fluid line 14 to the drive unit 11. As a result of the fluid flow, a driving torque is thus generated, which is transmitted to the transport unit 12 via the at least one magnetic coupling 17, 18. As a result of this, the transport unit can, for example, suck the thermofluid 3 into the transport unit 12 and expel it again at a different location, a fluid flow being realizable in the thermofluid 3 within the module enclosure 2. With appropriate routing out of the transport unit, the output thermofluid 3 can be used to effect, for instance, a circular flow inside the module 1. This circular flow serves, in particular, to improve the transfer of heat between the high-temperature battery cells 50 and the thermofluid 3.

The drive unit 11 and the fluid energy machine 10 are supplied with a driving torque exclusively by the fluid stream 16 in the fluid line 14. This driving torque is provided indirectly, via the pump 35, which is connected, outside of the module 1, to the fluid circuit 15. For the purpose of additionally providing thermal energy by means of the fluid stream 16, the latter may also additionally be supplied with thermal energy, by means of a heating device 13, which is likewise connected in the fluid circuit 15. Following supply of the fluid stream 16 to the module 1, heat can likewise be supplied and removed by a thermal interaction with the thermofluid 3. In addition, but not expressly shown in the present case, the fluid circuit 15 may also comprise a suitable cooling source, in order, for instance, also to cool the fluid stream 16 down to lower temperatures.

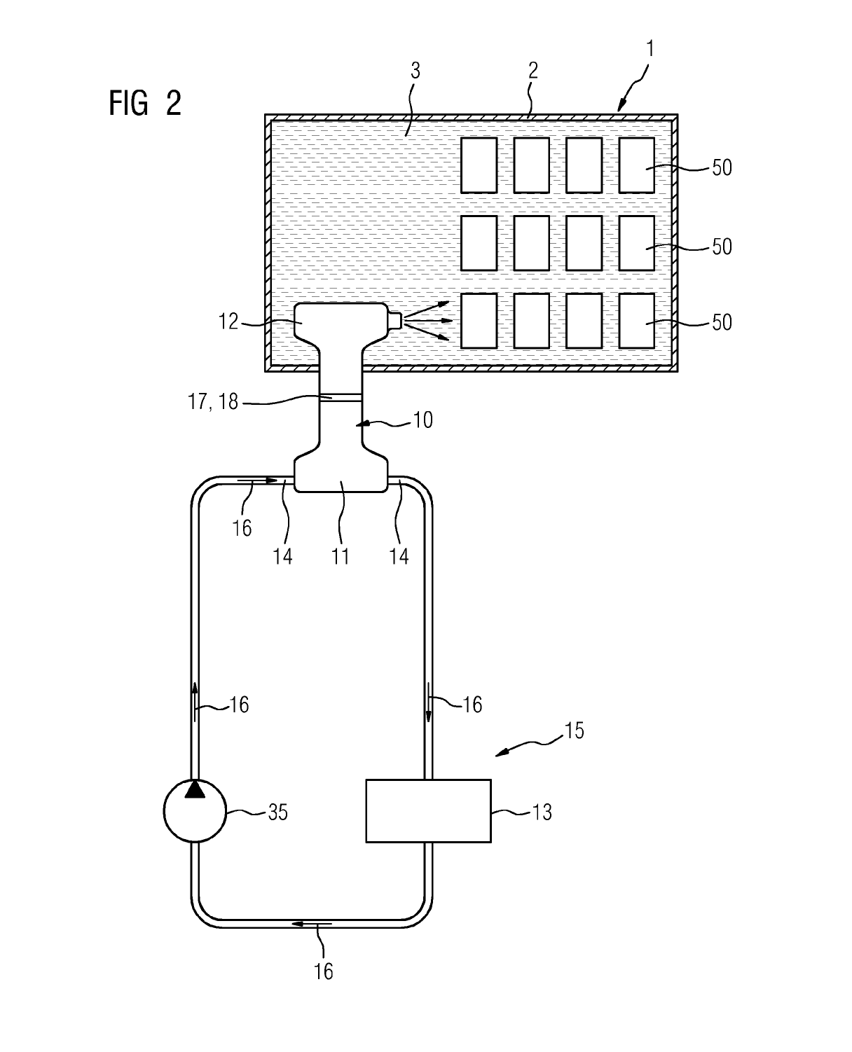

FIG. 2 shows a schematic view of a second embodiment of the module 1 according to the invention, in which there is a fluid energy machine 10 integrated into the module enclosure 2. The embodiment thus differs from that shown in FIG. 1 primarily in that the fluid energy machine 10 is not completely accommodated inside the module enclosure 2, but is partly disposed outside of the module enclosure 2. According to the embodiment, the fluid energy machine is integrated into the module enclosure 2 in such a manner that the housing of the fluid energy machine 10 is connected to the wall of the module enclosure 2, in particular welded, in the region of the at least one magnetic coupling 17, 18. To that extent, for example, the drive unit 11 can easily be removed by pulling, with the need to open the module 1.

FIG. 3 shows a first embodiment of a system according to the invention that comprises a number of individual modules 1. The modules 1 in this case may be realized as shown in FIG. 1. Whereas, in the present case, a serial connection of individual modules 1 is shown, this may be replaced by any other form of connection, in particular a parallel connection. According to the embodiment, the individual modules 1 are interconnected in such a manner that an output of a fluid line 14 is connected to the input of a fluid line 14 of an adjacent module 1.

In order to achieve a selective adjustment of the fluid stream 16 in the fluid lines 14, the fluid circuit 15 may have one or more valves 20 that, with appropriate open-loop or closed-loop control, can supply the required quantities of kinetic energy, or thermal energy, to the modules 1. Particularly in this case is a solution in which individual modules 1 can be individually adjusted (not shown in the present case) by respectively assigned valves 20.

FIG. 4 shows a first embodiment of the fluid energy machine 10, such as that which may be provided, for example, in the module 1 shown in FIG. 1, or in the system 100 shown in FIG. 2. In this case, the fluid energy machine 10 has a drive unit 11 and a transport unit 12, which are coupled in rotation to each other by means of two magnetic couplings 17 and 18. Provided via the fluid line 14, for the purpose of operating the drive unit 11, is a fluid stream 16 that, after acting upon a first impeller 29, causes the shaft 23 of the drive unit 11 to rotate. Provided at the end of the shaft 23 that is opposite the first impeller 29 there is a first inner magnet 25, which is inserted in a first containment shell 21, The first containment shell 21 in this case has a first outer magnet 26, which is disposed such that, when the drive unit 11 is fully inserted in the containment shell 21, the first inner magnet 25 and the first outer magnet 26 are exactly opposite each other. The first inner magnet 25 and the first outer magnet 26 in this case may be replaced by a number of individual magnets.

When the shaft 23 of the drive unit 11 is acted upon, a torque is transmitted, beyond the first containment shell 21, to the connecting shaft 19, owing to the magnetic coupling between a first inner magnet 25 and a first outer magnet 26. This torque then causes an associated rotation of the connecting shaft 19, disposed on which, on the side opposite the first containment shell 21, there is a second containment shell 22. The transport unit 12 is partially inserted in this second containment shell 22, this being in such a manner that, again, a second inner magnet 27 is opposite a second outer magnet 28 and, upon rotation of the second outer magnet 28, a torque can be transmitted to the second inner magnet 27. Again, both the second outer magnet 28 and the second inner magnet 27 may be replaced by a number of individual magnets. These magnets are, in particular, neodymium permanent magnets having a high thermal stability.

The transmission of torque from the second outer magnet 28 to the second inner magnet 27 causes a rotation of the shaft 24 of the transport unit 12, such that a second impeller 30, which is mechanically coupled to the shaft 24, can be driven. In the case of the fluid energy machine 10 being used in a module 1, described previously, this second impeller 30 is then able to suck in thermofluid 3 and to expel it again in an appropriate manner, such that, for instance, a selective flow of the thermofluid 3 in the module 1, not shown further, can be generated.

Further embodiments are given by the dependent claims.

1.-11. (canceled)

12. A high-temperature battery module comprising:
a number of high-temperature battery cells, having a module enclosure that is at least partly filled with a thermofluid, which thermofluid is designed for an operating temperature range of the high-temperature battery cells of between 200° C. and 400° C.,
a fluid energy machine which is disposed in the module enclosure or is partly integrated into the module enclosure, which fluid energy machine has a drive unit and a transport unit, which are each coupled to the other for transmitting a rotational force, and wherein the drive unit is fluidically connected to at least one fluid line of an at least partly external fluid circuit, such that it is energized by a fluid stream in the fluid line, and wherein the drive unit does not have any other connection for supply by a further, external, energy source.

13. The high-temperature battery module as claimed in claim 12,
wherein the drive unit and the transport unit are coupled to each other by at least one magnetic coupling.

14. The high-temperature battery module as claimed in claim 12,
wherein the transport unit imparts a flow to the thermofluid in the high-temperature battery module, which flow is suitable for thermally conditioning the high-temperature battery module by interaction with the thermofluid.

15. The high-temperature battery module as claimed in claim 12,
wherein the fluid in the fluid line differs from the thermofluid.

16. The high-temperature battery module as claimed claim 12,
wherein the fluid circuit is thermally connected to a heating device by which the fluid in the fluid line is thermally conditioned.

17. The high-temperature battery module as claimed in claim 12,
wherein the high-temperature battery module is realized in a fluid-tight manner.

18. A system comprising at least two high-temperature battery modules as claimed in claim 12,
wherein the at least two high-temperature battery modules are both fluidically connected to a single, at least partly external, fluid circuit to energize the respective drive units of the high-temperature battery modules.

19. The system as claimed in claim 18,
wherein the at least partly external fluid circuit has a number of valves, which adjust the fluid stream in the fluid line to or in a high-temperature battery module.

20. The high-temperature battery module as claimed in claim 13,
wherein the drive unit and the transport unit are coupled to each other by two magnetic couplings.

21. The high-temperature battery module as claimed claim 16,
wherein the fluid circuit thermally is connected to the heating device outside of the high-temperature battery module.
